(19) United States
(12) Patent Application Publication
(10) Pub. No.: US 2013/0025460 A1
(43) Pub. Date: Jan. 31, 2013

(54) FUEL VAPOR PROCESSING APPARATUS

(71) Applicant: Shota YAMANAKA, Obu-shi (JP)

(72) Inventor: Shota YAMANAKA, Obu-shi (JP)

(73) Assignee: AISAN KOGYO KABUSHIKI KAISHA, Obu-shi (JP)

(21) Appl. No.: 13/558,437

(22) Filed: Jul. 26, 2012

(30) Foreign Application Priority Data
Jul. 28, 2011 (JP) 2011-165095

(51) Int. Cl. B01D 53/02

(52) U.S. Cl. 96/144

(57) ABSTRACT

A fuel vapor processing apparatus may include a case defining an adsorption chamber containing adsorbent, so that fuel vapor introduced into the adsorption chamber is adsorbed by the adsorbent and fuel vapor is desorbed from the adsorbent by air flowing through the adsorption chamber. A desorption promoting unit may include a retaining frame and a desorption promoter configured to promote desorption of the fuel vapor from the adsorbent. The desorption promoter may be fitted into the retaining frame. The retaining frame may be fitted into the adsorption chamber, so that the desorption promoter does not directly contact an inner wall of the case defining the adsorption chamber.

This application claims priority to Japanese patent application serial number 2011-165095, the contents of which are incorporated herein by reference.

### BACKGROUND OF THE INVENTION

1. Field of the Invention

Embodiments of the present invention relate to fuel vapor processing apparatus used for processing vapor of fuel that is used, for example, for internal combustion engines of automobiles.

2. Description of the Related Art

In a known canister serving as a fuel vapor processing apparatus, fuel vapor is introduced into an adsorption chamber of a case so as to be adsorbed by activated carbon serving as adsorbent. The fuel vapor may be desorbed from the activated carbon by air flowing through the adsorption chamber. In order to achieve an improvement in terms of fuel vapor desorption performance, there has been proposed to arrange a spiral heat generator in the adsorption chamber to heat the activated carbon during desorption (See, for example, Japanese Laid-Open Utility Model Publication No. 5-21158).

In the canister disclosed in Japanese Laid-Open Utility Model Publication No. 5-21158, the spiral heat generator is supported by a spiral rib of a heater guide that is arranged in the adsorption chamber. This document does not provide a detailed explanation as to how the heater guide and the heat generator are assembled within the adsorption chamber. Judging from the drawings, however, one side of the heat generator is only held in contact with the rib of the heater guide, so that it is to be assumed that the heat generator is supported on the rib of the heater guide previously arranged in the adsorption chamber. Further, because the heat generator is in the form of a thin film that is easily deformed, the heat generator is likely to suffer deformation when it is mounted in the adsorption chamber. Such deformation of the heat generator is undesirable since it leads to a reduction in the filling factor of the activated carbon with respect to the adsorption chamber. Also in the case that the heat generator has a honeycomb structure, a similar problem is involved.

Therefore, there has been a need in the art for a fuel vapor processing apparatus capable of preventing a desorption promoter from being deformed during assembling within an adsorption chamber.

### SUMMARY OF THE INVENTION

A fuel vapor processing apparatus may include a case defining an adsorption chamber containing adsorbent, so that fuel vapor introduced into the adsorption chamber is adsorbed by the adsorbent and fuel vapor is desorbed from the adsorbent by air flowing through the adsorption chamber. A desorption promoting unit may include a retaining frame and a desorption promoter configured to promote desorption of the fuel vapor from the adsorbent. The desorption promoter may be fitted into the retaining frame. The retaining frame may be fitted into the adsorption chamber, so that the desorption promoter does not directly contact an inner wall of the case defining the adsorption chamber.

### BRIEF DESCRIPTION OF THE DRAWINGS

FIG. 1 is a sectional view of a fuel vapor processing apparatus according to a first embodiment;

FIG. 2 is a perspective view of a desorption promoting unit of the fuel vapor processing apparatus;

FIG. 3 is an exploded perspective view of the components of the desorption promoting unit;

FIG. 4 is a sectional view of a fuel vapor processing apparatus according to a second embodiment;

FIG. 5 is a perspective view of a desorption promoting unit of the fuel vapor processing apparatus according to the second embodiment;

FIG. 6 is an exploded perspective view of the components of the desorption promoting unit of the fuel vapor processing apparatus according to the second embodiment;

FIG. 7 is a sectional view of a fuel vapor processing apparatus according to a third embodiment;

FIG. 8 is a perspective view of a desorption promoting unit of the fuel vapor processing apparatus according to the third embodiment;

FIG. 9 is an exploded perspective view of the components of a heating device of the desorption promoting unit according to the third embodiment;

FIG. 10 is a bottom view of a connector portion of a retaining frame of the desorption promoting unit according to the third embodiment;

FIG. 11 is a sectional view taken along the arrow line XI-XI of FIG. 10;

FIG. 12 is a sectional view illustrating the relationship between the connector portion of the retaining frame and a connector portion of a case according to the third embodiment;

FIG. 13 is a sectional view illustrating the relationship between a connector portion of a retaining frame and a case according to a fourth embodiment;

FIG. 14 is a perspective view of a desorption promoting unit according to a fifth embodiment;

FIG. 15 is a sectional view of a part of a desorption promoting unit according to a sixth embodiment;

FIG. 16 is a sectional view of a part of a desorption promoting unit according to a seventh embodiment;

FIG. 17 is a sectional view of a fuel vapor processing apparatus according to an eighth embodiment;

FIG. 18 is a sectional view of a desorption promoting unit of the fuel vapor processing apparatus according to the eighth embodiment;

FIG. 19 is an exploded sectional view of the components of the desorption promoting unit according to the eighth embodiment;

FIG. 20 is a sectional view of a part of a desorption promoting unit according to a ninth embodiment; and

FIG. 21 is a sectional view of a part of a retaining frame of a desorption promoting unit according to a tenth embodiment.

### DETAILED DESCRIPTION OF THE INVENTION

Each of the additional features and teachings disclosed above and below may be utilized separately or in conjunction with other features and teachings to provide improved fuel vapor processing apparatus. Representative examples of the present invention, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings. Various examples will now be described with reference to the drawings.

In one example, a fuel vapor processing apparatus may include a case defining an adsorption chamber containing adsorbent, so that fuel vapor introduced into the adsorption chamber is adsorbed by the adsorbent and fuel vapor is desorbed from the adsorbent by air flowing through the adsorption chamber. A desorption promoter may have a honeycomb structure and may be configured to promote desorption of the fuel vapor from the adsorbent. A retaining frame may be configured to be positioned relative to the adsorption chamber through fitting therein in an axial direction and to retain the desorption promoter as the desorption promoter is fitted with the retaining frame in the axial direction. The retaining frame and the desorption promoter retained by the retaining frame may form a desorption promoting unit that is assembled into the adsorption chamber.

With this construction, the desorption promoter can be easily mounted to the retaining frame at a position on the outside of the adsorption chamber by retaining the desorption promoter by the retaining frame to form the desorption promoting unit. Further, since the desorption promoting unit formed by retaining the desorption promoter by the retaining frame can be assembled into the adsorption chamber, it is not necessary to apply an external force to the desorption promoter during the assembling operation. Thus, as compared with the case where the desorption promoter is directly mounted to the adsorption chamber, it is more advantageous in that it is possible to prevent deformation of the desorption promoter during mounting to the adsorption chamber. Eventually, it is possible to prevent a reduction in the filling factor of the adsorbent into the adsorption chamber. Further, the retaining frame can retain the desorption promoter in a stable manner.

The retaining frame may be formed as a double frame having an inner frame portion and an outer frame portion. The desorption promoter may be fitted into the inner frame portion, and the outer frame portion may be fitted into the adsorption chamber. With this construction, for example, by preparing retaining frames having same inner frame portions and different outer frame portions used for different adsorption chambers, it is possible to fit the same desorption promoters to different adsorption chambers. Further, by preparing retaining frames having same outer frame portions and different inner frame portions used for different desorption promoters, it is possible to fit different desorption promoters into the same adsorption chamber. The term “same desorption promoters” refers to desorption promoters each having a fitting configuration (sectional configuration) capable of fitting with the same inner frame portions. The term “different desorption promoters” refers to desorption promoters having different fitting configurations (sectional configurations) for fitting with different inner frame portions.

The desorption promoter may include a heater generating heat through electricity supply, and a radiator configured to radiate the heat generated by the heater. The retaining frame may include a connector portion capable of connecting the heater to an external wiring. Therefore, it is possible to easily and stably connect the heater of the desorption promoter to a connector portion of the retaining frame as the desorption promoter is retained by the retaining frame. Further, by connecting the external wiring to the connector portion of the retaining frame, the heater and the external wiring can be easily connected to each other.

The desorption promoter may be a heat radiator. In this connection, the retaining frame may be formed of a material having high heat conductivity and may be heated by a heater generating heat through electricity supply. Therefore, the retaining frame may be heated by heat generation of the heater through electricity supply, and the heat may be radiated from the radiator, whereby it is possible to promote desorption of the fuel vapor.

A contact portion of the retaining frame positioned for contacting with a wall portion of the adsorption chamber may be formed of a material having low heat conductivity. Therefore, it is possible to inhibit transmission of heat from the retaining frame to the wall portion of the adsorption chamber. Thus, it is possible to inhibit radiation of heat from the heater to the atmosphere via the retaining frame and the wall portion of the adsorption chamber, whereby it is possible to reduce heat energy loss of the heater.

The case may have a port, and the retaining frame may be configured to contact a stepped portion formed within the adsorption chamber on the side of the port. Because the retaining frame may contact with the stepped portion, the fitting position of the retaining frame with respect to the adsorption chamber can be easily determined, and therefore, the retaining frame can be easily positioned. As a result, it is possible to easily mount the retaining frame.

The port may include a charge port for introducing fuel vapor into the adsorption chamber, and a purge port for purging fuel vapor desorbed from the adsorbent. The retaining frame may be provided with a partition wall dividing a space portion of the adsorption chamber on the side of the charge port and the purge port into a charge port side space portion and a purge port side space portion. Because the partition wall of the retaining frame divides the port side space portion within the adsorption chamber into the charge port side space portion and the purge port side space portion, it is possible to suppress disorder or so-called disturbance in air/fuel (A/F) ratio due to fluctuations in the purge gas concentration.

The desorption promoter may include a first promoter and a second promoter fitted with opposite sides of the retaining frame with respect to the axial direction of the retaining frame. Therefore, it is possible to easily assemble the first and second desorption promoters into the adsorption chamber.

The retaining frame may have a wall portion dividing the adsorption chamber into two compartments respectively fitting with the first promoter and the second promoter, and the wall portion may define therein a space communicating between the two compartments. With this arrangement, it is possible to achieve an improvement in terms of DBL performance. The term “DBL performance” refers to a performance determined under the DBL regulations in the United States regarding gasoline vapor (HC) discharged into the atmosphere from a vehicle left to stand.

The space defined in the wall portion of the retaining frame may have a passage sectional area smaller than that of each of the two compartments. With this arrangement, it is possible to restrict flow of gas between the two compartments. As a result, it is possible to achieve an improvement in terms of DBL performance.

A determination device for determining the fitting position of the retaining frame may be provided between the wall portion of the adsorption chamber and the retaining frame. With this arrangement, it is possible to easily determine the fitting position of the retaining frame that may retain the first and second desorption promoters on opposite sides in the axial direction, and therefore, it is possible to easily perform the positioning operation. As a result, it is possible to achieve an improvement in terms of the mounting of the retaining frame that retains the two desorption promoters.

The retaining frame may have an engagement portion capable of engaging with an end piece portion of the desorption promoter protruding from an outer side surface of the desorption promoter. Therefore, by engaging the end piece portion of the desorption promoter with the engagement portion of the retaining frame, it is possible to perform positioning of the desorption promoter on the end piece portion.

A hollow space may be formed in the retaining frame, and a heat storage material including a phase change substance may be accommodated in the hollow space. Therefore, due to latent heat of the heat storage material accommodated in the hollow space of the retaining frame, it is possible to suppress an increase in the temperature of the adsorbent during adsorption of the fuel vapor to thereby achieve an improvement in terms of adsorption performance. In addition, it is possible to suppress a reduction in the temperature of the adsorbent during desorption of the fuel vapor to thereby achieve an improvement in terms of desorption performance. Further, in the case that the fuel vapor processing apparatus has a heater, it is possible to achieve a reduction in the requisite power for the heater by utilizing the latent heat of the heat storage material.

In the following, embodiments will be described with reference to the drawings.

### First Embodiment

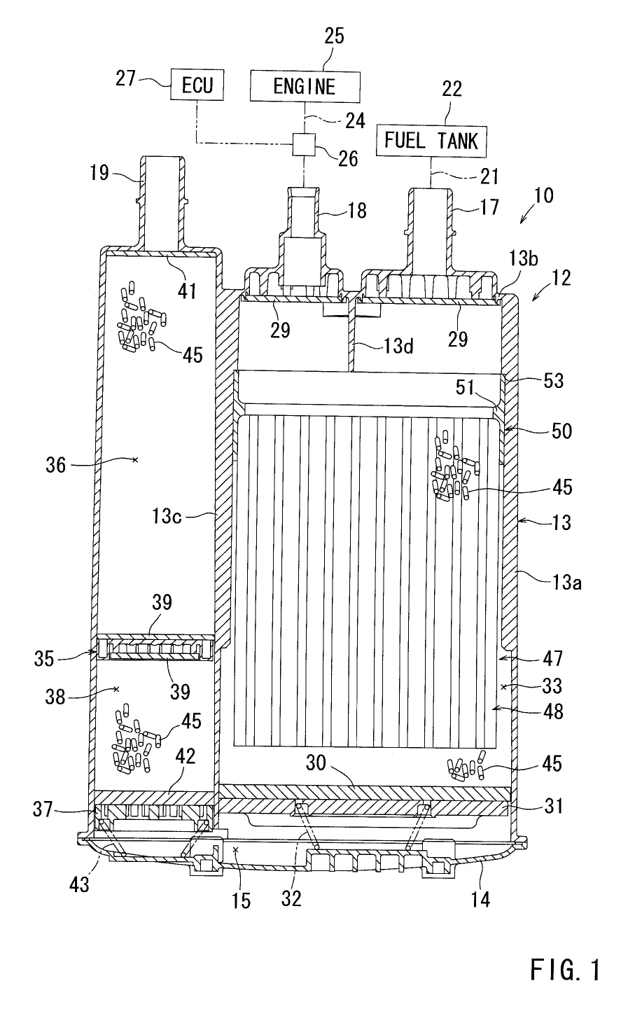

The first embodiment will be described. By way of example, a fuel vapor processing apparatus according to the present embodiment is configured as a canister that may be mounted to a vehicle such as an automobile. FIG. 1 is a sectional view of the fuel vapor processing apparatus. For the sake of convenience in illustration, the upper, lower, right, and left sides of the fuel vapor processing apparatus as described in FIG. 1 will be regarded as a reference; the obverse side of the plane of FIG. 1 will be defined as the front side, and the opposite side thereof will be defined as the rear side of the apparatus. The directions of the fuel vapor processing apparatus with respect to the vehicle, to which the apparatus is mounted, may be set as appropriate.

The basic construction of the fuel vapor processing apparatus will be described. As shown in FIG. 1, the fuel vapor processing apparatus 10 is formed, for example, of resin, and is equipped with a case 12 in the form of an elongated rectangular box. The case 12 has a case main body 13. The case main body 13 has a side wall 13a formed in a rectangular-tube-like configuration, and an end wall 13b closing the upper end opening of the side wall 13a. The lower end opening of the case main body 13 is closed by a cover member 14. Formed within the case main body 13 is a partition wall 13c dividing the interior space of the case body 13 into two right and left chambers. The partition wall 13c extends straight downwards from the end wall 13b. The right and left chambers of the case main body 13 communicate with each other via a communication passage 15 formed between the case main body 13 and the cover member 14. As a result, there is formed a U-shaped gas passage composed of the right chamber and the left chamber of the case main body 13 and the communication passage 15.

Formed with the end wall 13b of the case main body 13 are a tank port 17 and a purge port 18 communicating with the right chamber, and an atmosphere port 19 communicating with the left chamber. The tank port 17 communicates with a fuel tank 22 (more specifically, a space defined inside of the fuel tank 22 and occupied by gas) via a fuel vapor path 21. The purge port 18 communicates with an engine 25 (more specifically, a portion of an intake pipe on the downstream side of a throttle valve) via a purge path 24. Further, a purge valve 26 is provided in the way of the purge path 24. The purge valve 26 is controlled to be opened and closed by a so-called engine control unit (ECU) 27 that serves as a control device. The atmosphere port 19 is opened into the atmosphere. The ports 17, 18, and 19 are formed so as to protrude from the upper surface of the end wall 13b. The tank port 17 may be also called as “charge port.” The engine 25 may be an internal combustion engine.

The upper end portion of the right chamber of the case main body 13 is divided into two right and left space portions by a partition wall 13d. That is, the upper end portion of the right chamber is divided into a space portion on the tank port 17 side and a space portion on the purge port 18 side. Further, at the lower end opening of the right chamber of the case main body 13, a gas passable perforated plate 31 formed, for example, of resin, is provided so as to close the lower end opening. As a result, a first adsorption chamber 33 is formed in the right chamber of the case main body 13.

At the upper end of the first adsorption chamber 33, that is, at the upper end of the first adsorption chamber 33 on the side of the tank port 17 and at the upper end of the same on the side of the purge port 18, there are respectively provided filters 29 so as to extend across the upper ends. Further, a filter 30 is overlaid with the upper surface of the perforated plate 31. Further, a spring member 32 consisting of a coil spring is interposed between the opposing surfaces of the perforated plate 31 and of the cover member 14. The spring member 32 urges the perforated plate 31 upwardly.

At an intermediate portion in the vertical direction (the direction of flow of gas along a straight path portion of the gas path) of the left chamber of the case main body 13, there is horizontally provided a buffer plate 35 formed, for example, of resin. The buffer plate 35, which is formed, for example, of resin, has gas passability. As a result, a third adsorption chamber 36 is formed on the upper side of the buffer plate 35 in the left chamber of the case main body 13. Further, at the lower end opening of the left chamber of the case main body 13, a gas passable perforated plate 37 formed, for example, of resin, is provided so as to extend across the opening. As a result, a second adsorption chamber 38 is formed on the lower side in the left chamber of the case main body 13. Further, on the upper and lower surfaces of the buffer plate 35, filters 39 are disposed so as to extend over the entire upper and lower surfaces. Further, at the upper end of the third adsorption chamber 36, a filter 41 is provided so as to extend across the upper end. Further, in the second adsorption chamber 38, a filter 42 is overlaid with the upper surface of the perforated plate 37. A spring member 43 consisting of a coil spring is interposed between the opposing surfaces of the perforated plate 37 and the cover member 14. The spring member 43 urges the perforated plate 37 upwardly.

Each of the first, second and third adsorption chambers 33, 38, and 36 is filled with granular adsorbent 45 that can adsorb fuel vapor and can allow desorption of fuel vapor. Granular activated carbon may be used as the granular adsorbent 45. Further, as the granular activated carbon, it is possible to employ crushed activated carbon, granulated activated carbon formed by a granulation process of a mixture of granular or powder activated and a binder, etc. The filters 29, 30, 39, 41, and 42 may be formed, for example, of non-woven fabric of resin or urethane foam.

Next, the operation of a fuel vapor processing system incorporating the above-described fuel vapor processing apparatus 10 will be described. The fuel vapor processing system may include the fuel vapor processing apparatus 10, the fuel vapor path 21, the purge path 24, the purge valve 26, the ECU 27, etc.

When the vehicle engine 25 is stopped (during adsorption of fuel vapor), the purge valve 26 is closed, and a gas (fuel vapor gas) containing the fuel vapor generated in the fuel tank 22 is introduced into the first adsorption chamber 33 from the fuel vapor path 21 via the tank port 17. The fuel vapor contained in the fuel vapor gas introduced is adsorbed by the adsorbent 45 in the first adsorption chamber 33. And, a portion of the fuel vapor which has not been adsorbed by the adsorbent 45 in the first adsorption chamber 33 may flow into the communication passage 15 and further into the second adsorption chamber 38, so that the non-adsorbed portion of the fuel vapor may be adsorbed by the adsorbent 45 in the second adsorption chamber 38. Further, a portion of the fuel vapor which has still not been adsorbed by the adsorbent 45 in the second adsorption chamber 38 is introduced into the third adsorption chamber 36 via the buffer plate 35, and is adsorbed by the adsorbent 45 in the third adsorption chamber 36. Finally, the gas containing substantially only air is discharged into the atmosphere via the atmosphere port 19.

When a purge operation is performed (i.e., when a purge control process is performed during the operation of the engine 25), the purge valve 26 is opened, whereby an intake negative pressure is applied to the gas passage in the case 12 from the purge path 24 via the purge port 18. In conjunction with this, air from the atmosphere (fresh air) is introduced into the third adsorption chamber 36 from the atmosphere port 19 as purge air. After desorption of fuel vapor from the adsorbent 45 in the third adsorption chamber 36, the purge air is introduced into the second adsorption chamber 38 via the buffer plate 35, and desorbs the fuel vapor from the adsorbent 45 in the second adsorption chamber 38. Further, the purge air (gas) containing desorbed fuel vapor is introduced into the first adsorption chamber 33 via the communication passage 15, so that the purge air desorbs the fuel vapor from the adsorbent 45 in the first adsorption chamber 33. Subsequently, the purge air containing fuel vapor is purged into the engine 25 from the purge port 18 via the purge path 24, so that fuel vapor contained in the purge air is combusted in the engine 25.

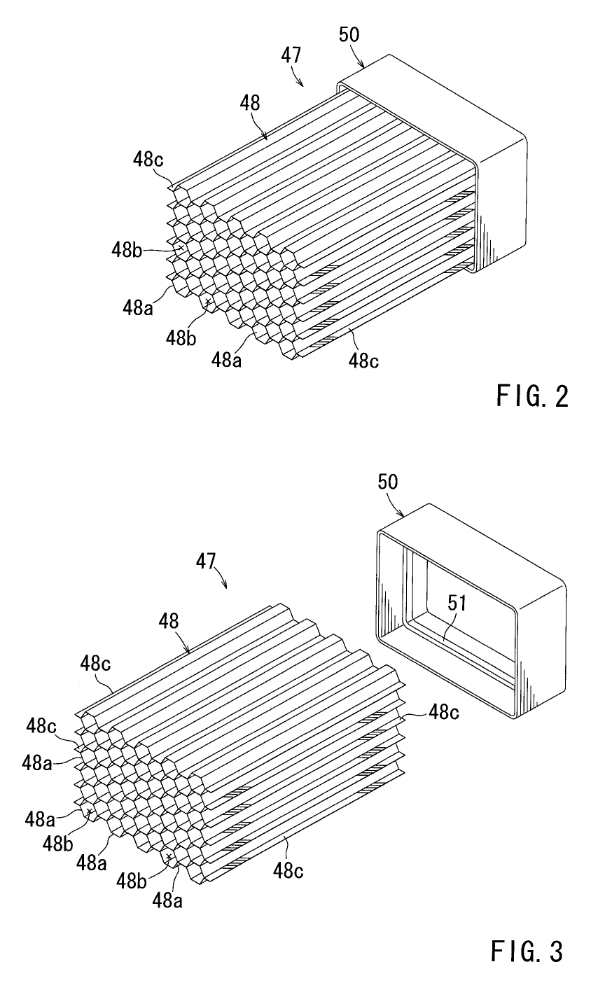

Next, a desorption promoting unit 47, which is assembled into the first adsorption chamber 33 of the fuel vapor processing apparatus 10 prior to the filling of the adsorbent 45 will be described. FIG. 2 is a perspective view of the desorption promoting unit 47, and FIG. 3 is an exploded perspective view of the components of the desorption promoting unit 47.

As shown in FIG. 2, the desorption promoting unit 47 includes a honeycomb core 48 and a retaining frame 50. The honeycomb core 48 is formed as a rectangular parallelepiped shape elongated in an axial direction (See FIG. 3). The honeycomb core 48 is formed of a material having heat conductivity higher than that of the adsorbent 45 (See FIG. 1). For example, the material of the honeycomb core 48 may be a metal foil, such as aluminum foil, or aluminum alloy. The honeycomb core 48 has a number of hollow hexagonal-tube-shaped cells 48b each having six cell walls 48a connected in series with each other in the circumferential direction. In this embodiment, the cells 48b extend in the axial direction of the honeycomb core 48. In the following explanation, the direction perpendicular to the outer side surfaces of the cell walls 48a of the honeycomb core 48 (the vertical direction in FIG. 3), that is, the direction perpendicular to the side surfaces of the cell walls 48a, will be referred to as the lengthwise direction, and the direction perpendicular thereto, that is, the direction in which end piece portions 48c formed by vertically cutting the cells 48b are oriented, will be referred to as the left and right direction (widthwise direction). The honeycomb core 48 serves as a desorption promoter.

As shown in FIG. 3, the retaining frame 50 has a rectangular tube-like configuration and may be formed, for example, of resin. The retaining frame 50 is sized so as to be capable of axially fitted with the wall portions of the first adsorption chamber 33 (i.e., the front side portion, rear side portion and right side portion of the side wall 13a, and the partition wall 13c of the case main body 13 defining the first adsorption chamber 33) (See FIG. 1). Further, the retaining frame 50 is formed so as to be capable of retaining one end portion (upper end portion) of the honeycomb core 48 through fitting in the axial direction. More specifically, it is possible to retain the honeycomb core 48 in the retaining frame 50 through fitting one end portion of the honeycomb core 48 into the retaining frame 50 with a fitting force that is large enough to enable slight fitting of the one end of the honeycomb core 48 into the retaining frame 50 (See FIG. 2). Here, the “fitting force large enough to enable slight fitting” refers to a fitting force large enough to fit the honeycomb core 48 by utilizing its elastic deformation with no or substantially no plastic deformation. Further, at the center with respect to each inner side surface of the retaining frame 50, a stopper portion 51 is formed in a circumferentially continuous fashion (See FIG. 3) and protrudes inwardly from the inner side surfaces. When the honeycomb core 48 is retained in the retaining frame 50, the outer peripheral portion of the insertion side end surface (upper end surface) of the honeycomb core 48 may abut the stopper portions 51, so that the honeycomb core 48 can be positioned at a predetermined fitting position with respect to the retaining frame 50 (See FIG. 1).

By retaining the honeycomb core (desorption promoter) 48 in the retaining frame 50 through axial fitting, the desorption promoting unit 47 may be assembled (See FIG. 2). The desorption promoting unit 47 is assembled into the first adsorption chamber 33 through fitting in the axial direction (upward from below as viewed in FIG. 1). Then, the insertion side end surface (upper end surface) of the retaining frame 50 abuts a stepped portion 53 formed on the wall portion of the first adsorption chamber 33, whereby the retaining frame 50 is positioned at a predetermined fitting position. At the same time, the honeycomb core 48 may be positioned such that its axial direction (the vertical direction thereof as seen in FIG. 1) is parallel to the direction of flow of gas through the first adsorption chamber 33 (the vertical direction in FIG. 1). The stepped portion 53 is formed inside of the first adsorption chamber 33 on the side of the ports 17 and 18. The adsorbent 45 is filled into the first adsorption chamber 33 having the honeycomb core 48 disposed therein and also into the interior of each cell 48b of the honeycomb core 48.

In the above-described fuel vapor processing apparatus 10 (See FIG. 1), during adsorption of the fuel vapor, the increase in temperature at the central portion of the interior of the first adsorption chamber 33 is larger than the increase in temperature at the outer peripheral portion of the interior of the first adsorption chamber 33. However, the heat at the central portion of the interior of the first adsorption chamber 33 may be transferred to the outer peripheral portion via the honeycomb core 48. Therefore, the increase in the temperature at the central portion of the interior of the first adsorption chamber 33 is suppressed, and the adsorption performance at the central portion of the interior of the first adsorption chamber 33 is improved. During purging of the fuel vapor, that is, during desorption of the fuel vapor, the reduction in the temperature at the central portion of the interior of the first adsorption chamber 33 is larger than the reduction in the temperature at the outer peripheral portion of the interior of the first adsorption chamber 33. However, the heat at the outer peripheral portion of the interior of the first adsorption chamber 33 may be transferred to the central portion via the honeycomb core 48. As a result, the reduction in temperature at the central portion of the interior of the first adsorption chamber 33 is suppressed, and the desorption performance at the central portion of the interior of the first adsorption chamber 33 is improved.

In the above-described fuel vapor processing apparatus 10, the desorption promoting unit 47 is assembled by retaining the honeycomb core 48 in the retaining frame 50, and therefore, the operation for mounting the honeycomb core 48 to the retaining frame 50 can be easily performed at a position outside the first adsorption chamber 33. Further, the desorption promoting unit 47 assembled by retaining the honeycomb core 48 in the retaining frame 50 is assembled into the first adsorption chamber 33, so that there is no need to apply any external force to the honeycomb core 48 at the time of mounting thereof. As a result, in comparison with the case in which the honeycomb core 48 is directly mounted to the first adsorption chamber 33, it is possible to further prevent deformation (more specifically, plastic deformation) of the honeycomb core 48 when it is mounted to the first adsorption chamber 33. Eventually, it is possible to prevent a reduction in the filling ratio of the adsorbent 45 with respect to the first adsorption chamber 33. Further, due to the use of the retaining frame 50, it is possible to retain the honeycomb core 48 in the first adsorption chamber 33 in a stable manner.

Further, the retaining frame 50 abuts the stepped portion 53 formed within the first adsorption chamber 33 on the side of the ports 17 and 18. Therefore, it is possible to easily determine the fitting position of the retaining frame 50 with respect to the first adsorption chamber 33. In other words, the retaining frame 50 can be easily positioned. As a result, it is possible to improve the mounting performance of the retaining frame 50.

The desorption promoting unit 47 may be disposed in at least one of the first adsorption chamber 33, the second adsorption chamber 38, and the third adsorption chamber 36 of the case 12. The number of adsorption chambers 33, 38, 36 in the case 12 is not limited to three; it may be increased or reduced as appropriate. Further, the sectional configuration of the cells 48b of the honeycomb core 48 may be changed to any other polygonal configuration other than the hexagonal one.

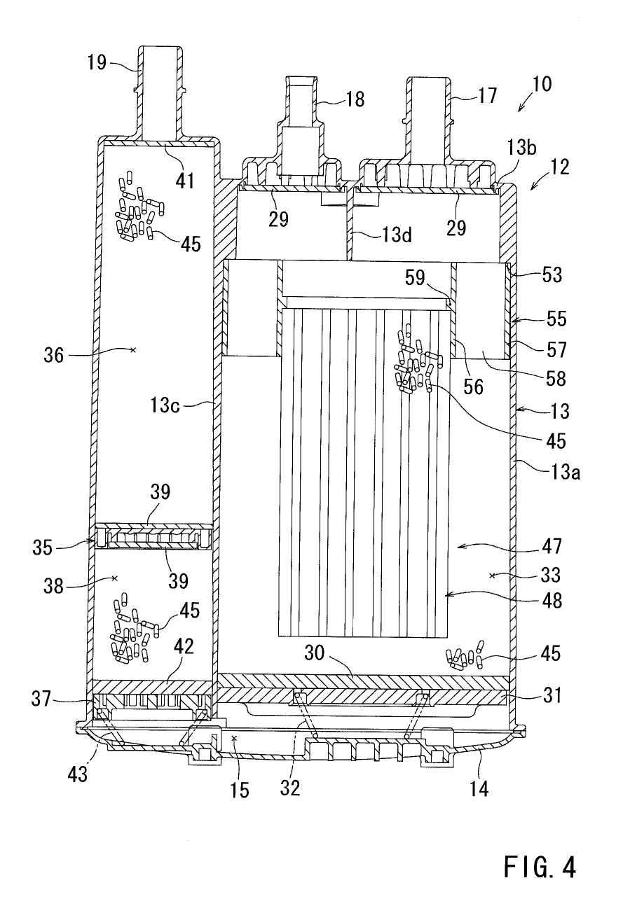

Second to tenth embodiments will now be described with reference to FIGS. 4 to 21. These embodiments are modifications of the first embodiment. Therefore, the description of these embodiments will be focused to features that are different from the first embodiment. In addition, in FIGS. 4 to 21, like members are given the same reference numerals as the first embodiment and the description of these members will not be repeated.

### Second Embodiment

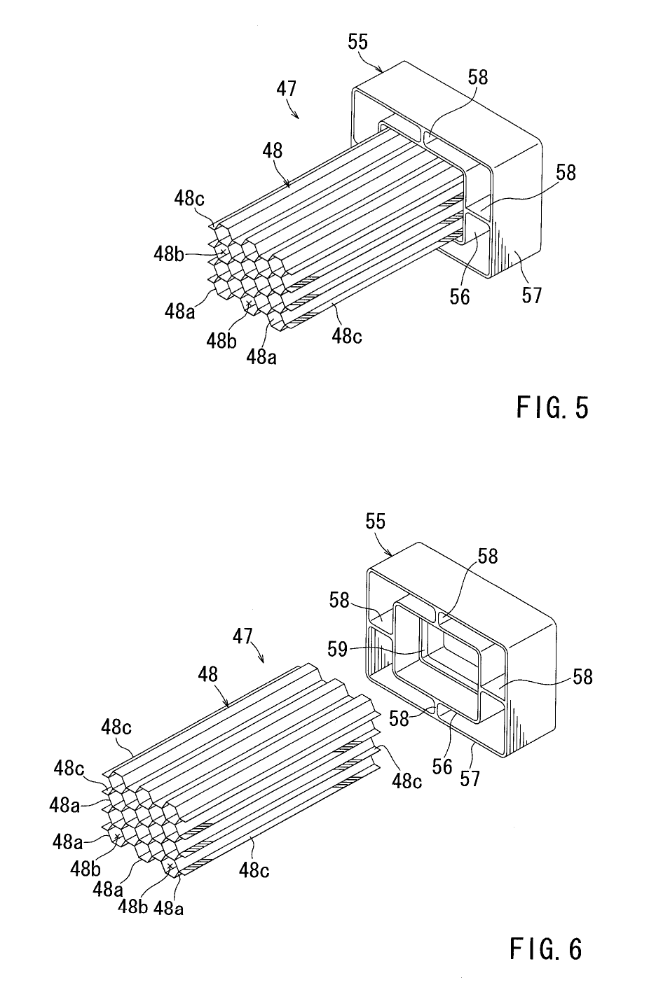

The second embodiment will now be described. As shown in FIGS. 4 and 5, in the present embodiment, the retaining frame 50 of the desorption promoting unit 47 (See FIG. 2) of the first embodiment is replaced with a retaining frame 55. As shown in FIG. 6, the retaining frame 55 is formed as a double frame having an inner frame portion 56 and an outer frame portion 57. The outer frame portion 57 and the inner frame portion 56 are connected by rib-like connecting portions 58 connecting between the intermediate portions of side plate portions of the outer frame portion 57 and the intermediate portions of the corresponding side plate portions of the inner frame portion 56.

Further, at the central portion with respect to each inner side surface of the inner frame portion 56, there is formed a stopper portion 59 similar to the stopper portion 51 (see FIG. 3) of the first embodiment. The honeycomb core 48 (indicated by the same reference numeral as the honeycomb core of the first embodiment) is configured to be fitted into the inner frame portion 56, and the outer frame portion 57 is configured to be fitted into the first adsorption chamber 33 (see FIGS. 4 and 5). Further, the insertion side end portion (upper end portion) of the outer frame portion 57 of the retaining frame 55 abuts the stepped portion 53 formed on the wall portion of the first adsorption chamber 33, so that the retaining frame 55 can be positioned at a predetermined fitting position.

With the retaining frame 55 of the present embodiment, it is possible, for example, to provide same inner frame portions 56 for outer frame portions 57 corresponding to different types of first adsorption chambers 33 (more specifically, first adsorption chambers 33 of different cross sectional configurations), whereby it is possible to arrange same honeycomb cores 48 (honeycomb cores 48 having a fitting configuration (sectional configuration) capable of fitting into the same inner frame portions 56) for different types of first adsorption chambers 33. On the other side, it is possible to provide same outer frame portions 57 for inner frame portions 56 corresponding to different types of honeycomb cores 48 (honeycomb cores 48 having different fitting configurations (sectional configurations) with respect to the inner frame portions 56), whereby it is possible to arrange different types of honeycomb cores 48 for same first adsorption chambers 33 (more specifically, first adsorption chambers having the same cross sectional configuration).

### Third Embodiment

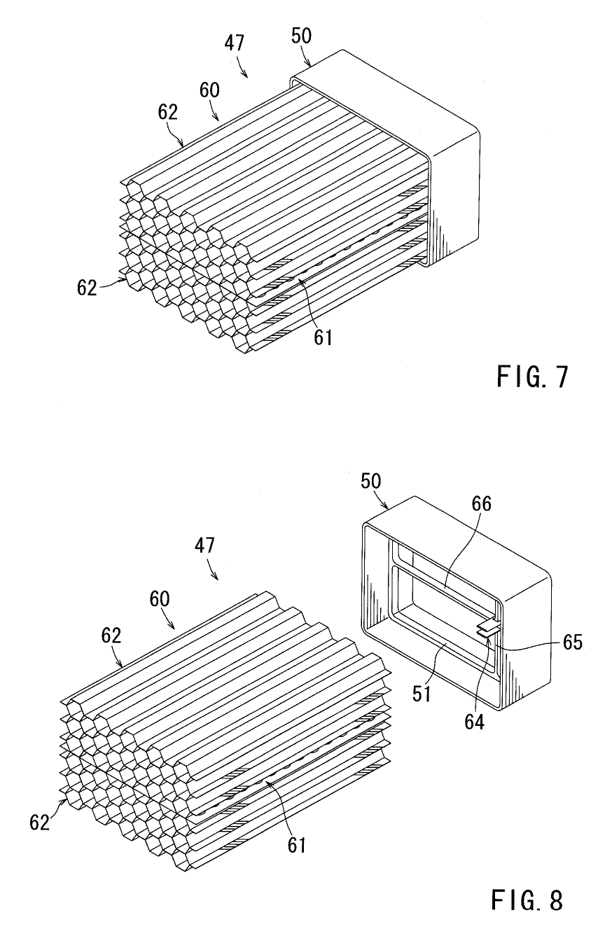

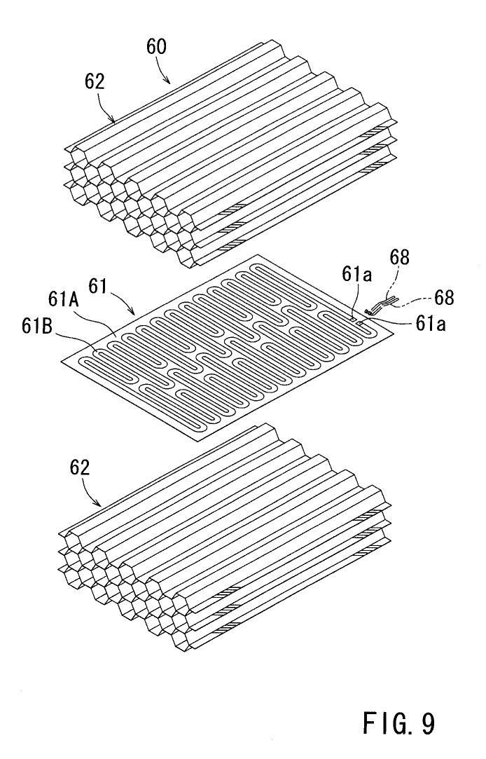

The third embodiment of the present invention will be described. As shown in FIGS. 7 and 8, in the present embodiment, the honeycomb core 48 (see FIG. 2) of the desorption promoting unit 47 is replaced with a heating device 60 having a honeycomb structure. FIG. 9 is an exploded perspective view of the components of the heating device 60 of the desorption promoting unit 47. For the sake of convenience in illustration, the upper, lower, right, and left sides of the heating device 60 are determined in conformity with those of the fuel vapor processing apparatus 10 of the first embodiment.

As shown in FIG. 9, the heating device 60 includes a planar heater 61 configured to generate heat through electricity supply and a pair of radiators 62 bonded to the front and back surfaces (the upper and lower surfaces as seen in FIG. 9) of the planar heater 61 and configured to radiate the heat generated by the heater 61. The external appearance of the heating device 60 may be similar to that of the honeycomb core 48 (See FIG. 3) of the first embodiment (See FIG. 8). For example, the heater 61 may be a planar PTC heater, which is composed of a substrate 61A and a heating member 61B formed thereon. A pair of electrodes 61a may be formed at one end portion (upper end portion) of the heating member 61 (See FIG. 9). The two heat radiators 62 may be arranged symmetrically with the heater 61 positioned therebetween, so that the heat generated by the heating member 61B of the heater 61 may be radiated to the outside. In the present embodiment, each of the two heat radiators 62 employed is of a construction similar to that of the honeycomb core 48 (See FIG. 3) of the first embodiment. Further, the heating device 60 is constituted by integrating the heater 61 with the two heat radiators 62 (See FIG. 8). The heating device 60 serves as a desorption promoting device.

As shown in FIG. 8, the retaining frame 50 has a connector portion 64. The connector portion 64 is positioned so as to correspond to the electrodes 61a of the heater 61 of the heating device 60 (see FIG. 9).

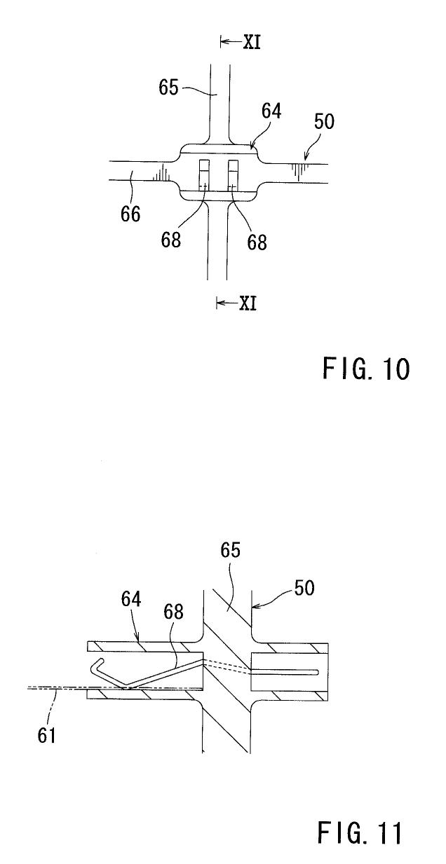

As shown in FIG. 8, the connector portion 64 is located at a position where a lengthwise bridge member 65 extending between the surfaces opposing each other in the lengthwise direction (the vertical direction in FIG. 8) of the stopper portion 51 and a widthwise bridge member 66 extending between the surfaces opposing each other in the widthwise direction of the stopper portion 51 cross each other (see FIG. 10). Further, the connector portion 64 has a pair of terminals 68 protruding in the vertical direction (horizontal direction as viewed in FIG. 11). The lower end portions (the left end portions in FIG. 11) of the two terminals 68 are electrically connected to the two electrodes 61a (see FIG. 9) of the heater 61 by utilizing elastic deformation (deflection) thereof when the heating device 60 is retained by the retaining frame 50. The connection between the two terminals 68 and the two electrodes 61a leads to electrically connect between the connector portion 64 and the heater 61.

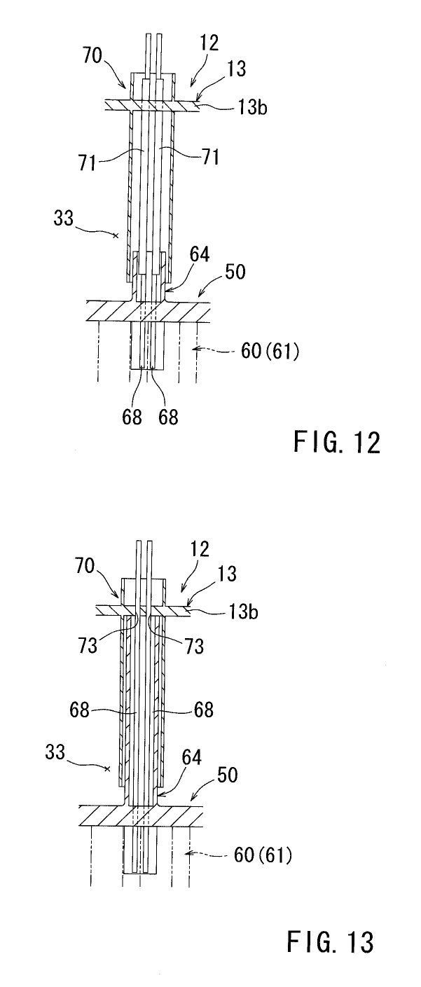

As shown in FIG. 12, the end wall 13b of the case main body 13 of the case 12 is formed with a connector portion 70 corresponding to the connector portion 64 of the retaining frame 50. The connector portion 70 has a pair of vertically protruding terminals 71 disposed therein. As the desorption promoting unit 47 is assembled into the first adsorption chamber 33 (see FIG. 1), the lower end portions of the two terminals 71 are electrically connected to the upper end portions of the two terminals 68 of the connector portion 64 of the retaining frame 50. Further, an electric wiring from an external connector (not shown) of the ECU 27 (See FIG. 1) is connected to the upper end portions of the terminal 71 of the connector portion 70. The ECU 27 may control the electricity supply to the heater 61. The electrical wiring of the external connector and the two terminals 71 of the connector portion 70 of the case 12 electrically connected to the electrical wiring may be collectively referred to as an external wiring device. The connection between the two terminals 68 and the two terminals 71 leads to electrically connect between the connector portion 64 and the connector portion 70.

According to the fuel vapor processing apparatus 10 of the present embodiment, during desorption of fuel vapor (i.e., during purging of fuel vapor), electricity is supplied to the heater 61 (See FIG. 7) of the heating device 60 of the desorption promoting unit 47 under the control of the ECU 27 (See FIG. 1), so that the heater 61 (more specifically, the heat generating member 61B) generates heat, and this heat is radiated from the two heat radiators 62. As a result, the reduction in the temperature of the adsorbent 45 during the desorption process is suppressed, and an improvement in terms of desorption performance is achieved.

With the fuel vapor processing apparatus 10 described above, the heating device 60 is retained by the retaining frame 50 and, at the same time, the heater 61 of the heating device 60 can be connected to the connector portion 64 of the retaining frame 50 easily and in a stable manner. Further, by connecting the external wiring (the connector portion 70 of the case 12 electrically connected to the electrical wiring of the external connector) to the connector portion 64 of the retaining frame 50, it is possible to easily effect the connection between the heater 61 and the external wiring. While in this example the heat radiators 62 are provided on both sides of the heater 61, one of the heat radiators 62 may be omitted.

Further, the retaining frame 50 includes a portion that may contact the wall portions of the first adsorption chamber 33 (i.e., the front side portion, rear side portion, right side portion of the side wall 13a, and the partition wall 13c of the case main body 13 defining the first adsorption chamber 33), and a part of the retaining frame 50 excluding the terminals 68 is formed of resin, that is, a material of low heat conductivity. Accordingly, it is possible to inhibit transfer of heat from the retaining frame 50 to the wall portion of the first adsorption chamber 33. As a result, it is possible to inhibit radiation of heat to the atmosphere from the heater 61 via the retaining frame 50 and the wall portion of the first adsorption chamber 33, whereby it is possible to achieve a reduction in heat energy loss of the heater 61.

### Fourth Embodiment

The fourth embodiment will be described. The present embodiment is a modification of the third embodiment described above.

As shown in FIG. 13, in the present embodiment, the two terminals 71 (see FIG. 12) of the connector portion 70 of the case 12 of the third embodiment are omitted. In this connection, the upper end portions of the two terminals 68 of the connector portion 64 of the retaining frame 50 protrude upwards through a terminal insertion hole 73 formed in the end wall 13b of the case main body 13 as the desorption promoting unit 47 is assembled into the first adsorption chamber 33 (see FIG. 1). An appropriate seal structure (not shown) may be provided between the two terminals 68 and the terminal insertion hole 73 so that the fuel vapor of the first adsorption chamber 33 may not leak.

### Fifth Embodiment

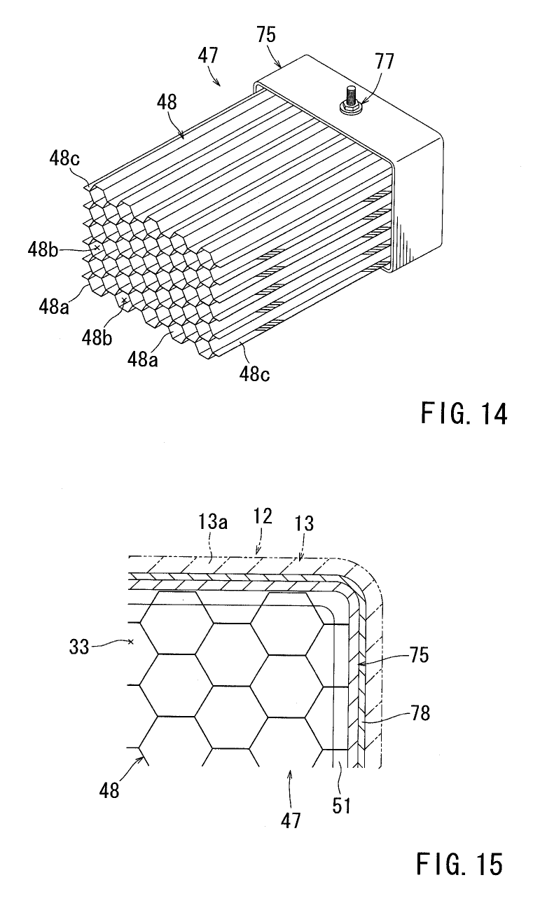

The fifth embodiment will be described. The present embodiment is a modification of the first embodiment. As shown in FIG. 14, in the case of the present embodiment, the retaining frame 50 (see FIG. 2) of the desorption promoting unit 47 of the first embodiment is replaced with a retaining frame 75.

While the retaining frame 50 of the first embodiment is formed of resin, the retaining frame 75 of this embodiment is formed of a material having relatively high heat conductivity. The high heat conductivity material may be aluminum, copper, or stainless steel. Further, a heater 77 configured to generate heat through electricity supply is mounted to the retaining frame 75. The heater 77 may be a PTC heater, which can be mounted to the retaining frame 75 by using a screw, so that the retaining frame 75 can be heated. A lead wire (not shown) of the heater 77 may be electrically connected to the lower end portions of the two terminals 71 (see FIG. 12) of the connector portion 70 of the case main body 13 as in the third embodiment. Further, a relief groove (not shown) for avoiding interference with the heater 77 during the fitting operation of the retaining frame 75 is formed in the wall portion (the front side portion of the side wall 13a of the case main body 13) of the first adsorption chamber 33 (see FIG. 1) of the case main body 13. The honeycomb core 48 serves as a heat radiator in this embodiment.

With the desorption promoting unit 47 of the present embodiment, as electricity is supplied to the heater 77 under the control by the ECU 27 (see FIG. 1) during the desorption process (i.e., during the purging process), the retaining frame 75 is heated by heat generated by the heater 77, and the heat is then radiated from the honeycomb core 48. As a result, the reduction in temperature of the adsorbent 45 during the desorption process is suppressed, and an improvement is achieved in terms of desorption performance. In other words, it is possible to promote desorption of the fuel vapor.

### Sixth Embodiment

The sixth embodiment will be described. The present embodiment is a modification of the fourth embodiment. As shown in FIG. 15, in the present embodiment, the retaining frame 75 of the desorption promoting unit 47 of the fifth embodiment is provided with a heat insulation portion 78 formed of a material having relatively low heat conductivity and surrounding the contact portion, i.e., the outer side surface of the retaining frame 75, which contacts the wall portion of the first adsorption chamber 33 (which includes the front side portion, rear side portion, and right side portion of the side wall 13a of the case main body 13 forming the first adsorption chamber 33, and the partition wall 13c (See FIG. 1); FIG. 15 shows a part of the wall portion). The low heat conductivity material may be resin.

According to the present embodiment, the contact portion of the retaining frame 75 for contacting with the wall portion of the first adsorption chamber 33 is surrounded by the heat insulating portion 78 having low heat conductivity. Accordingly, it is possible to inhibit transfer of heat from the retaining frame 75 to the wall portion of the first adsorption chamber 33. As a result, it is possible to inhibit heat from radiation to the atmosphere from the heater 77 via the retaining frame 75 and the wall portion of the first adsorption chamber 33, thereby making it possible to achieve a reduction in the heat energy loss of the heater 77.

### Seventh Embodiment

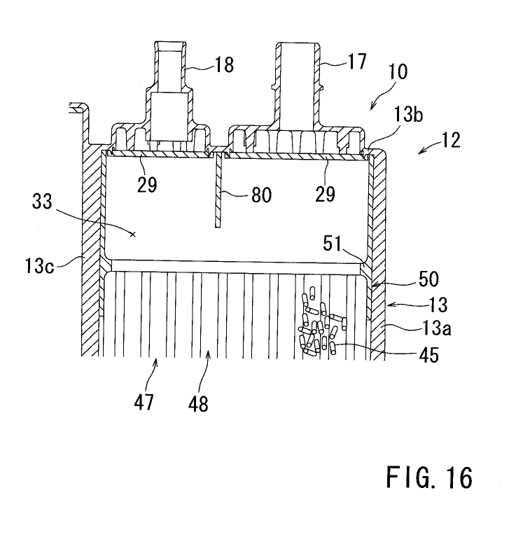

The seventh embodiment will be described. The present embodiment is a modification of the first embodiment. As shown in FIG. 16, according to the present embodiment, the retaining frame 50 of the first embodiment is extended upwardly, and, within the extended frame portion, there is formed a plate-like partition wall 80 dividing the space within the extended frame portion into right and left space portions. Therefore, the partition wall 13d and the stepped portion 53 (See FIG. 1) of the case main body 13 of the first embodiment are omitted.

The upper end surface of the retaining frame 50 abuts the end wall 13b within the first adsorption chamber 33, whereby the retaining frame 50 is positioned at a predetermined fitting position. As a result, it is possible to easily assemble the retaining frame 50. In this way, the end wall 13b serves as a stepped portion for abutment to the end surface of the retaining frame 50.

In the retaining frame 50 of the present embodiment, a portion of the space within the first adsorption chamber 33 on the side of the tank port 17 and the purge port 18 is divided into a space portion on the side of the tank port 17 and a space portion on the side of the purge port 18 by the partition wall 80 in place of the partition wall 13d of the case main body 13 of the first embodiment. As a result, it is possible to suppress disorder or so-called disturbance in the air/fuel (A/F) ratio due to fluctuations in the concentration of the purge gas, and to prevent deterioration in drivability.

### Eighth Embodiment

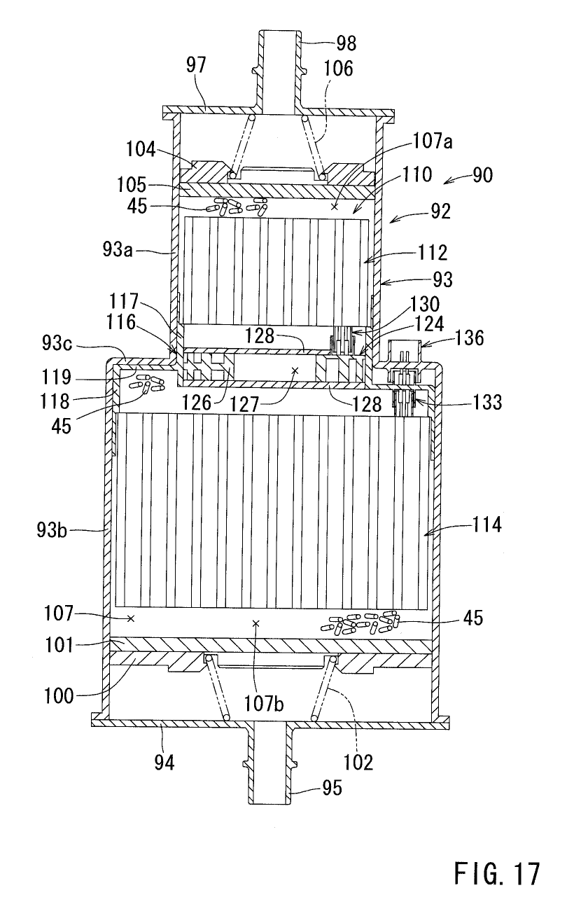

The eighth embodiment will be described. The present embodiment is a modification of the third embodiment. As shown in FIG. 17, a fuel vapor processing apparatus 90 of the present embodiment includes a desorption promoting unit 110 including two heating devices 112 and 114 retained by a single retaining frame 116. Each of the heating devices 112 and 114 is configured to be similar to the heating device 60 of the third embodiment. The desorption promoting unit 110 is assembled into a case 92.

The case 92 of the fuel vapor processing apparatus 90 may be formed, for example, of resin, and may have an elongated rectangular box shape with a stepped portion. The case 92 has a case main body 93. The case main body 93 has a tubular shape with two upper and lower stage portions. The case main body 93 has a side wall 93a of the upper stage, a side wall 93b of the lower stage, and a horizontal connection wall 93c connecting opposing ends of the two side walls 93a and 93b. The side wall 93a of the upper stage has a smaller passage sectional area (opening area) than that of the side wall 93b of the lower stage.

The lower end opening of the side wall 93b of the lower stage is closed by a lower cover member 94. A connection port 95 protruding downwards is formed on the lower cover member 94. The connection port 95 serves as both the tank port 17 and the purge port 18 of the first embodiment (see FIG. 1). Although not shown, as in the first embodiment (see FIG. 1), the connection port 95 may communicate with the fuel tank 22 via the fuel vapor path 21 and also communicates with the engine 25 via the purge path 24. Instead of the connection port 95, it is also possible to form a tank port and a purge port on the lower cover member 94.

The upper end opening of the side wall 93a of the upper stage is closed by an upper cover member 97. The upper cover member 97 has an atmosphere port 98 protruding upwards. The atmosphere port 98 communicates with or is open into the atmosphere. As a result, a vertically extending straight gas passage is defined in the case 92.

At the lower end opening of the side wall 93b of the lower stage, there is provided a gas passable lower perforated plate 100 that may be formed, for example, of resin and positioned to extend across the opening. A filter 101 may be overlaid on the upper surface of the lower perforated plate 100. Further, a lower spring member 102 consisting of a coil spring is interposed between opposing surfaces of the lower perforated plate 100 and the lower cover member 94. The lower spring member 102 urges the lower perforated plate 100 upwardly. Further, at the upper end opening of the side wall 93a of the upper stage, there is provided a gas passable upper perforated plate 104 that may be formed, for example, of resin and may extend across of the opening. A filter 105 may be overlaid on the lower surface of the upper perforated plate 104. Further, an upper spring member 106 consisting of a coil spring may be interposed between opposing surfaces of the upper perforated plate 104 and the upper cover member 97. The upper spring member 106 urges the upper perforated plate 104 downwardly. Further, the passage portion between the two perforated plates 100 and 104 of the case main body 93 (more specifically, between the two filters 101 and 105) serves an adsorption chamber 107. The adsorption chamber 107 is filled with the adsorbent 48. The desorption promoting unit 110 may be assembled into the adsorption chamber 107 prior to the filling with the adsorbent 45. In this way, the case main body 93 serves as a wall portion of the adsorption chamber 107.

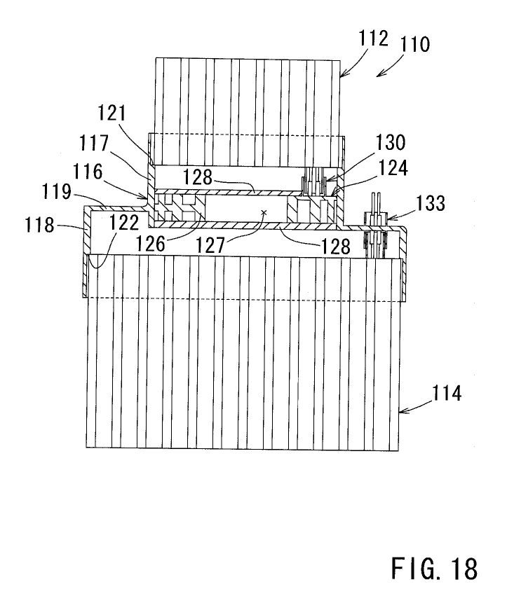

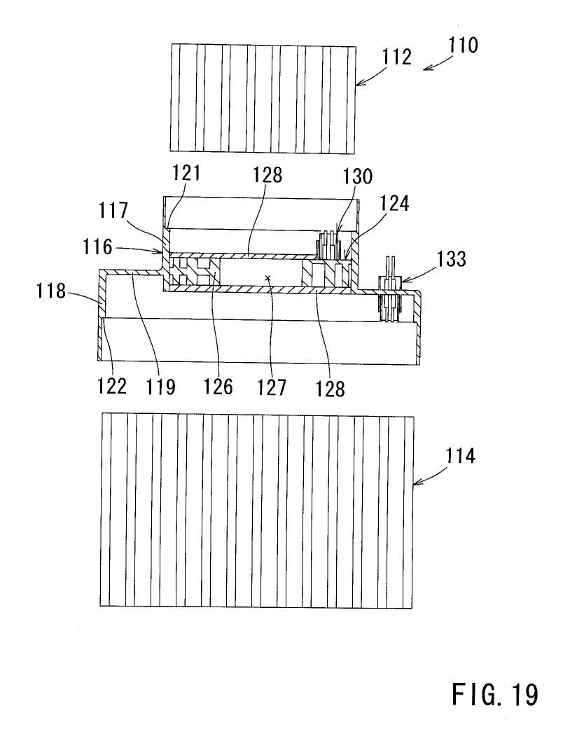

As shown in FIG. 18, the desorption promoting unit 110 is constituted by integrating the upper heating device 112, the lower heating device 114, and the retaining frame 116 with each other (see FIG. 19). The basic construction of each of the two heating devices 112 and 114 may be similar to that of the heating device 60 of the third embodiment (see FIGS. 8 and 9). Therefore, the heating devices 112 and 114 will not be described in detail. The upper heating device 112 is disposed within the inner space of the side wall 93a of the upper stage of the case main body 93, and the lower heating device 114 is disposed within the inner space of the side wall 93b of the lower stage of the case main body 93 (See FIG. 17). The two heating devices 112 and 114 serve as a desorption promoting device.

As shown in FIG. 19, the retaining frame 116 may be formed, for example, of resin and may have a stepped configuration with two upper and lower stages. The retaining frame 116 has an upper stage frame portion 117, a lower stage frame portion 118, and a horizontal connection portion 119 connecting opposing ends of the two frame portions 117 and 118. At an intermediate portion in the axial direction (vertical direction) of the inner side surface of the upper stage frame portion 117, there is formed an upper stage stopper portion 121. At an intermediate portion in the axial direction (vertical direction) of the inner side surface of the lower stage frame portion 118, there is formed a stepped lower stopper portion 122.

In the lower end portion of the upper stage frame portion 117, there is provided a partition wall portion 124 that may be formed, for example, of resin and may extend across the opening of the lower end portion. The partition wall portion 124 is formed to have a predetermined thickness in the axial direction (vertical direction) and divides the interior space into the interior of the upper stage frame portion 117 and the interior of the lower stage frame portion 118. Further, at the central portion of the partition wall portion 124, there is formed a cylindrical portion 126 in the form of a hollow cylinder extending in the axial direction. A space 127 is defined in the interior of the cylindrical portion 126 and communicates between the interior of the upper stage frame portion 117 and the interior of the lower stage frame portion 118. The space 127 serves as a narrowed passage having a passage sectional area smaller than that of the interior of the upper stage frame portion 117. Further, filters 128 are respectively disposed on both the upper and lower surfaces of the partition wall portion 124 so as to substantially entirely cover the partition wall portion 124. In this way, the partition wall portion 124 serves as a space forming wall portion.

An upper side connector portion 130 is formed on the right end portion of the partition wall portion 124. Further, a lower side connector portion 133 is formed on the right end portion of the connection portion 119. The connector portions 130 and 133 may have the same construction as the connector portion 64 of the third embodiment (see FIGS. 10 and 11), and therefore, the connector portions 130 and 133 will not be described in detail. Further, although not shown, at the connection portion 119 of the retaining frame 116 including the partition wall portion 124, the two terminals of the upper side connector portion 130 and the two terminals of the lower side connector portion 133 may be electrically connected to each other. Further, as shown in FIG. 17, on the connection wall 93c of the case main body 93, there is formed a connector portion 136 corresponding to the lower side connector portion 133. The connector portion 136 may have the same construction as the connector portion 70 of the third embodiment (see FIG. 12) and will not be described in detail.

As shown in FIG. 18, the lower end portion of the upper heating device 112 is retained by the upper stage frame portion 117 of the retaining frame 116 through fitting therein in the axial direction downwardly from above. As the upper heating device 112 is retained within the upper stage frame portion 117, the outer peripheral portion of the insertion side end surface (lower end surface) of the upper heating device 112 may contact the upper stopper portion 121, whereby the upper heating device 112 is positioned at a predetermined fitting position with respect to the upper stage frame portion 117. At the same time, the upper heating device 112 (more specifically, its heater) may be electrically connected to the upper side connector portion 130.

Further, the upper end portion of the lower heating device 114 is retained by the lower stage frame portion 118 through fitting therein in the axial direction upwardly from below. As the lower heating device 114 is retained within the lower stage frame portion 118, the outer peripheral portion of the insertion side end surface (upper end surface) of the lower heating device 114 may contact the lower stopper portion 122, whereby the lower heating device 114 is positioned at a predetermined fitting position with respect to the lower stage frame portion 118. At the same time, the lower heating device 114 (more specifically, the heater) may be electrically connected to the lower side connector portion 133. In this way, the desorption promoting unit 110 may be constituted by two heating devices 112 and 114 retained by the retaining frame 116.

As shown in FIG. 17, the desorption promoting unit 110 is assembled into the adsorption chamber 107 of the case 92 through fitting therein in the axial direction upward from below. Then, the upper stage frame portion 117 of the retaining frame 116 is fitted into the lower end portion of the upper stage side wall 93a of the case 92, and the lower stage frame portion 118 of the retaining frame 116 is fitted into the upper end portion of the lower stage side wall 93b of the case 92. Further, the connection portion 119 of the retaining frame 116 abuts the connection wall 93c of the case main body 93, whereby the retaining frame 116 is positioned at a predetermined fitting position that is the intermediate portion with respect to the direction of flow of gas through the adsorption chamber 107. The connection wall 93c of the case main body 93 and the connection portion 119 of the retaining frame 116 serve as a determination device for determining the position of the retaining frame 116.

Further, the lower side connector portion 133 is electrically connected to the connector portion 136 of the case 92. Further, the adsorption chamber 107 is divided into upper and lower compartments 107a and 107b by a partition wall portion 124 of the retaining frame 116. The heating devices 112 and 114 are respectively arranged in the compartments 107a and 107b. The adsorbent 45 may be filled into the compartments 107a and 107b of the adsorption chamber 107 and also into the cells 48b of the heat radiators, in which the heating devices 112 and 114 are respectively arranged. More specifically, the adsorbent 45 may be filled into the upper compartment 107a from the upper end opening of the case main body 93 in the state where the upper cover member 97 and the perforated plate 105 are removed. The adsorbent 45 may be filled into the lower compartment 107b from the upper end opening of the case main body 93 in the state where the lower cover member 94 and the perforated plate 100 are removed.

According to the fuel vapor processing apparatus 90 described above, the heating devices 112 and 114 are retained on both sides in the axial direction of the retaining frame 116, whereby the two heating devices 112 and 114 can be easily assembled into the adsorption chamber 107.

Further, due to the partition wall portion 124 of the retaining frame 116, the adsorption chamber 107 is divided into the compartments 107a and 107b respectively for the heating devices 112 and 114, and the space 127 is formed between the two compartments 107a and 107b for communication between the compartments 107a and 107b. As a result, it is possible to achieve an improvement in terms of DBL performance.

Further, in the partition wall portion 124 of the retaining frame 116, there is formed the space 127 whose passage sectional area is smaller than that of each of the two compartments 107a and 107b. Accordingly, due to the space 127, it is possible to regulate the flow of gas between the two compartments 107a and 107b. As a result, it is possible to achieve an improvement in terms of DBL performance.

Further, due to the determination device formed by the connection wall 93c of the case main body 93 and the connection portion 119 of the retaining frame 116, it is possible to easily determine the fitting position of the retaining frame 116 that retains the two heating devices 112 and 114 relative to the case main body 93 constituting the wall portion of the adsorption chamber 107. Therefore, it is possible to easily perform the positioning operation. As a result, it is possible to achieve an improvement in terms of ease of assembling of the retaining frame 116 that retains the two heating devices 112 and 114.

Further, it is possible to electrically connect the two heating devices 112 and 114 (more specifically, their heaters) to the two connector portions 64 of the retaining frame 116 easily and in a stable manner at the same time the two heating devices 112 and 114 are retained on the retaining frame 116. Further, by connecting the connector portion 136 of the case 92, which is electrically connected to the external wiring (external connector), to the connector portion 133 of the retaining frame 116, it is possible to easily perform the connection between the two heating devices 112 and 114 (more specifically, their heaters) and the external wiring.

Further, at the connection portion 119 of the retaining frame 116 inclusive of the partition wall portion 124, the upper side connector portion 130 and the lower side connector portion 133 are electrically connected to each other. As a result, the lower side connector portion 133 is electrically connected to the connector portion 136 of the case 92 and, at the same time, the upper side connector portion 130 is also electrically connected thereto. Accordingly, the single connector portion 136 of the case 92 can be used for the connector portions 130 and 133 of the two heating devices 112 and 114. As a result, it is possible to simplify the wiring for the connection between the two heating devices 112 and 114 (more specifically, their heaters) and the external wiring, so that a reduction in cost can be achieved. It is also possible to provide the case 92 with two connector portions respectively corresponding to the two heating devices 112 and 114.

### Ninth Embodiment

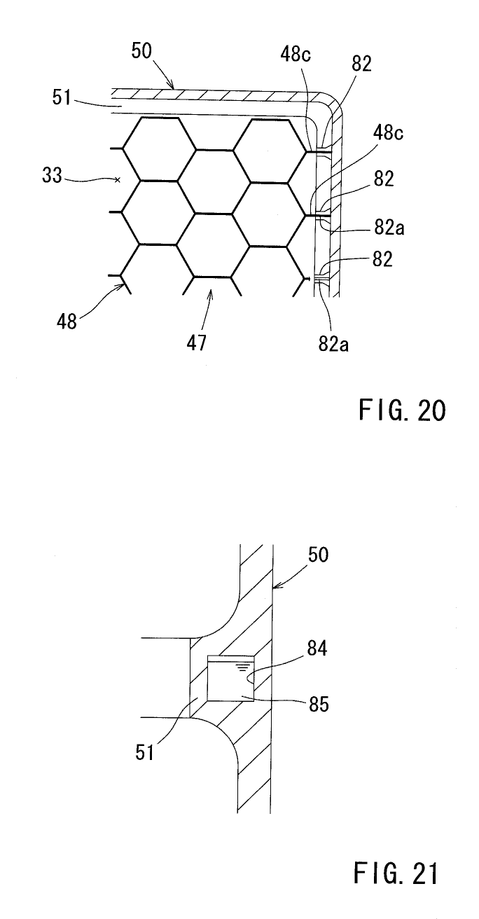

The ninth embodiment will be described. The present embodiment is a modification of the first embodiment. As shown in FIG. 20, in the present embodiment, a plurality of engagement portions 82 extend vertically straight from the right and left inner wall surfaces of the retaining frame 50 of the desorption promoting unit 47 of the first embodiment. The engagement portions 82 have straight engagement grooves 82a with which right side end piece portions 48c of the honeycomb core 48 are slidably engaged in the vertical direction (the direction perpendicular to the plane of FIG. 20). The engagement portions 82 may be provided by the number in correspondence with all the end piece portions 48c of the honeycomb core 48, or provided by the number in correspondence with selected one or more of the end piece portions 48c.

As the honeycomb core 48 is fitted into the retaining frame 50, the end piece portions 48c of the honeycomb core 48 may be slidably moved to engage with the engagement grooves 82a of the engagement portions 82.

As a result, it is possible to position the end piece portions 48c of the honeycomb core 48 with respect to the retaining frame 50, in particular, in the lengthwise direction (the vertical direction in FIG. 20) thereof. The engagement portions 82 having the engagement grooves 82a may be replaced with convex engagement portions configured to be engaged with concave portions each formed between two adjacent end piece portions 48c of the honeycomb core 48. Further, it is also possible to retain the honeycomb core 48 by the retaining frame 50 such that both the front and rear end surfaces of the honeycomb core 48 are brought into contact with the inner side surfaces in the lengthwise direction (the vertical direction in FIG. 20) of the retaining frame 50.

Further, it is possible to retain the honeycomb core 48 by the retaining frame 50 such that both the front and rear side surfaces of the honeycomb core 48 are spaced away from the inner side surfaces in the lengthwise direction (the vertical direction in FIG. 20) by a predetermined distance. In this case, by replacing the honeycomb core 48 of the present embodiment with, for example, the heating device 60 of the third embodiment (see FIG. 7), it is possible to inhibit dissipation into the atmosphere of heat from the heating device 60 via the retaining frame 50 and the wall portion of the first adsorption chamber 33. As a result, it is possible to reduce the heat energy loss of the heater 61 of the heating device 60.

### Tenth Embodiment

The tenth embodiment will be described. The present embodiment is a modification of the first embodiment. As shown in FIG. 21, according to the present embodiment, the retaining frame 50 has a hollow space 84, and a heat storage material 85 consisting of a phase change substance is contained in the hollow space 84. In the present embodiment, the hollow space 84 is formed in a thickened portion including the stopper portion 51 of the retaining frame 50.

According to the present embodiment, due to latent heat of the heat storage material 85 contained in the hollow space 84 of the retaining frame 50, it is possible to suppress an increase in the temperature of the adsorbent 45 during adsorption of the fuel vapor, so that an improvement is achieved in terms of adsorption performance. In addition, it is possible to suppress a reduction in the temperature of the adsorbent 45 during desorption of the fuel vapor, so that an improvement is achieved in terms of desorption performance. Further, if the retaining frame 50 of the present embodiment is used for the desorption promoting unit 47 (see FIG. 7) equipped with the heater 61 of the third embodiment, it is possible to reduce the requisite power for the heater 61 by utilizing the latent heat of the heat storage material 85. Further, if the retaining frame 50 of the present embodiment is used for the desorption promoting unit 47 (see FIG. 14) having the heater 77 of the fifth embodiment, it is possible to reduce the requisite power for the heater 77 by utilizing the latent heat of the heat storage material 85.

What is claimed is:

1. A fuel vapor processing apparatus comprising:
a case defining an adsorption chamber containing adsorbent, so that fuel vapor introduced into the adsorption chamber is adsorbed by the adsorbent and fuel vapor is desorbed from the adsorbent by air flowing through the adsorption chamber,
a desorption promoter having a honeycomb structure and configured to promote desorption of the fuel vapor from the adsorbent; and
a retaining frame configured to be positioned relative to the adsorption chamber through fitting therein in an axial direction and to retain the desorption promoter as the desorption promoter is fitted with the retaining frame in the axial direction,
wherein the retaining frame and the desorption promoter retained by the retaining frame form a desorption promoting unit that is assembled into the adsorption chamber.

2. The fuel vapor processing apparatus according to claim 1, wherein the retaining frame is formed as a double frame having an inner frame portion and an outer frame portion, the desorption promoter is fitted into the inner frame portion, and the outer frame portion is fitted into the adsorption chamber.

3. The fuel vapor processing apparatus according to claim 1, wherein the desorption promoter comprises a heater generating heat through electricity supply, and a radiator configured to radiate the heat generated by the heater, and wherein the retaining frame includes a connector portion capable of connecting the heater to an external wiring.

4. The fuel vapor processing apparatus according to claim 1, wherein the desorption promoter comprises a heat radiator, and wherein the retaining frame is formed of a material having high heat conductivity and is heated by a heater generating heat through electricity supply.

5. The fuel vapor processing apparatus according to claim 3, wherein a contact portion of the retaining frame positioned for contacting with a wall portion of the adsorption chamber is formed of a material having low heat conductivity.

6. The fuel vapor processing apparatus according to claim 1, wherein the case has a port, and the retaining frame is configured to contact a stepped portion formed within the adsorption chamber on the side of the port.

7. The fuel vapor processing apparatus according to claim 6, wherein the port includes a charge port for introducing fuel vapor into the adsorption chamber, and a purge port for purging fuel vapor desorbed from the adsorbent, and wherein the retaining frame is provided with a partition wall dividing a space portion of the adsorption chamber on the side of the charge port and the purge port into a charge port side space portion and a purge port side space portion.

8. The fuel vapor processing apparatus according to claim 1, wherein the desorption promoter includes a first promoter and a second promoter fitted with opposite sides of the retaining frame with respect to the axial direction of the retaining frame.

9. The fuel vapor processing apparatus according to claim 8, wherein the retaining frame has a wall portion dividing the adsorption chamber into two compartments respectively fitting with the first promoter and the second promoter, the wall portion defining therein a space communicating between the two compartments.

10. The fuel vapor processing apparatus according to claim 9, wherein the space defined in the wall portion of the retaining frame has a passage sectional area smaller than that of each of the two compartments.

11. The fuel vapor processing apparatus according to claims 8, wherein a determination device for determining the fitting position of the retaining frame is provided between the wall portion of the adsorption chamber and the retaining frame.

12. The fuel vapor processing apparatus according to claim 1, wherein the retaining frame has an engagement portion capable of engaging with an end piece portion of the desorption promoter protruding from an outer side surface of the desorption promoter.

13. The fuel vapor processing apparatus according to claim 1, wherein a hollow space is formed in the retaining frame, and wherein a heat storage material including a phase change substance is accommodated in the hollow space.

14. A fuel vapor processing apparatus comprising:
a case defining an adsorption chamber containing adsorbent, so that fuel vapor introduced into the adsorption chamber is adsorbed by the adsorbent and fuel vapor is desorbed from the adsorbent by air flowing through the adsorption chamber, and
a desorption promoting unit comprising a retaining frame and a desorption promoter configured to promote desorption of the fuel vapor from the adsorbent; wherein:
the desorption promoter is fitted into the retaining frame, and
the retaining frame is fitted into the adsorption chamber, so that the desorption promoter does not directly contact an inner wall of the case defining the adsorption chamber.

15. The fuel vapor processing apparatus according to claim 14, wherein the desorption promoter has a honeycomb structure including a plurality of honeycomb cells.

16. The fuel vapor processing apparatus according to claim 14, wherein the desorption promoter comprises a heat conductive material having a heat conductivity higher than that of the adsorbent.

17. The fuel vapor processing apparatus according to claim 14, wherein the desorption promoter comprises a heater.
